(19) United States
(12) Patent Application Publication
(10) Pub. No.: US 2021/0016351 A1
(43) Pub. Date: Jan. 21, 2021

(54) IRRADIATION DEVICE, METAL SHAPING DEVICE, METAL SHAPING SYSTEM, IRRADIATION METHOD, AND METHOD FOR MANUFACTURING METAL SHAPED OBJECT

(71) Applicant: FUJIKURA LTD., Tokyo (JP)

(72) Inventors: Hiroyuki Kusaka, Sakura-shi (JP); Masahiro Kashiwagi, Sakura-shi (JP)

(73) Assignee: FUJIKURA LTD., Tokyo (JP)

(21) Appl. No.: 16/979,590

(22) PCT Filed: Mar. 27, 2019
(86) PCT No.: PCT/JP2019/013358

§ 371 Date: Sep. 10, 2020

(30) Foreign Application Priority Data
Mar. 30, 2018 (JP) 2018-069700

(51) Int. Cl. B22F 3/105; B23K 26/06

(52) U.S. Cl. CPC B22F 3/1055; B33Y 10/00; B23K 26/0665; B23K 26/0648

(57) ABSTRACT

An aspect of the present invention makes it easier to increase a temperature of metal powder to a temperature at which a powder bed (PB) is sintered or melted. An irradiation device (13) includes: a galvano scanner (13a) which irradiates at least part of a powder bed (PB) with laser light; and a wavelength converting element (WCE) provided in an optical path of the laser light. The wavelength converting element (WCE) converts laser light inputted into the wavelength converting element to laser light containing harmonic wave light (HL) which has a shorter wavelength than the laser light inputted into the wavelength converting element.

### TECHNICAL FIELD

The present invention relates to an irradiation device and an irradiation method which are used in metal shaping. The present invention also relates to a metal shaping device including such an irradiation device and a metal shaping system including such a metal shaping device. The present invention also relates to a method for manufacturing a metal shaped object including such an irradiation method.

### BACKGROUND ART

As a method for manufacturing a three-dimensional metal shaped object, an additive manufacturing method is known in which a powder bed is used as a base material. The additive manufacturing method includes (1) an electron beam melting method in which a powder bed is melted and solidified, or sintered with use of an electron beam, and (2) a laser beam melting method in which a powder bed is melted and solidified, or sintered with use of a laser beam (see Non-Patent Literature 1).

### CITATION LIST

### Non-Patent Literature

[Non-patent Literature 1]

Akihiko Chiba, “Microstructure of Alloys Fabricated by Additive Manufacturing Using Electron Beam Melting”, Journal of the Society of Instrument and Control Engineers, Vol. 54, No. 6, June 2015, p 399-400

### SUMMARY OF INVENTION

### Technical Problem

The additive manufacturing method using laser beam melting utilizes energy of laser light absorbed by metal powder, among energy of laser with which the powder bed is irradiated, so as to increase a temperature of the metal powder. Accordingly, for example, in a case where (i) the laser light with which the powder bed is irradiated has a long wavelength and (ii) in particular, efficiency of absorption of the laser light into the metal powder is low, it may take time and effort to increase the temperature of the metal powder. In light of this and other viewpoints, there has been a problem in that it is difficult to increase the temperature of the metal powder to a temperature at which the powder bed is sintered or melted.

The present invention is accomplished in view of the above problems. An object of the present invention is to provide an irradiation device, a metal shaping device, a metal shaping system, an irradiation method, and a method for manufacturing a metal shaped object, each of which employs an additive manufacturing method using laser beam melting and is capable of easily increasing a temperature of metal powder to a temperature at which a powder bed is sintered or melted.

### Solution to Problem

In order to solve the above problem, an irradiation device in accordance with an aspect of the present invention is an irradiation device for use in metal shaping, the irradiation device including: an irradiating section which irradiates at least part of a powder bed with laser light; and a wavelength converting element provided in an optical path of the laser light, the wavelength converting element converting laser light inputted into the wavelength converting element to laser light containing harmonic wave light which has a shorter wavelength than the laser light inputted into the wavelength converting element.

In order to solve the above problem, an irradiation device in accordance with an aspect of the present invention is an irradiation device for use in metal shaping, the irradiation device including: a laser device which outputs laser light with which at least part of a powder bed is irradiated; and a wavelength converting element provided in an optical path of the laser light, the wavelength converting element converting laser light inputted into the wavelength converting element to laser light containing harmonic wave light which has a shorter wavelength than the laser light inputted into the wavelength converting element.

In order to solve the above problem, an irradiation method in accordance with an aspect of the present invention is an irradiation method, including the steps of: converting, with use of a wavelength converting element, laser light inputted into the wavelength converting element to laser light containing harmonic wave light which has a shorter wavelength than the laser light inputted into the wavelength converting element; and irradiating the powder bed with the laser light containing the harmonic wave light.

In order to solve the above problem, a manufacturing method of a metal shaping device in accordance with an aspect of the present invention is a method for manufacturing a metal shaped object, including the steps of: converting, with use of a wavelength converting element, laser light inputted into the wavelength converting element to laser light containing harmonic wave light which has a shorter wavelength than the laser light inputted into the wavelength converting element; and irradiating the powder bed with the laser light containing the harmonic wave light.

### Advantageous Effects of Invention

An aspect of the present invention can provide an irradiation device, a metal shaping device, a metal shaping system, an irradiation method, and a method for manufacturing a metal shaped object, each of which is capable of easily increasing a temperature of metal powder to a temperature at which a powder bed is sintered or melted.

### BRIEF DESCRIPTION OF DRAWINGS

FIG. 1 is a diagram illustrating a configuration of a metal shaping system in accordance with an embodiment of the present invention.

(a) of FIG. 2 is a diagram illustrating a configuration of an irradiation device included in the metal shaping system illustrated in FIG. 1. (b) of FIG. 2 is a plan view illustrating a powder bed used in the metal shaping system illustrated in FIG. 1.

FIG. 3 is a flowchart showing a flow of a method for manufacturing a metal shaped object in accordance with an embodiment of the present invention.

### DESCRIPTION OF EMBODIMENTS

(Configuration of Metal Shaping System)

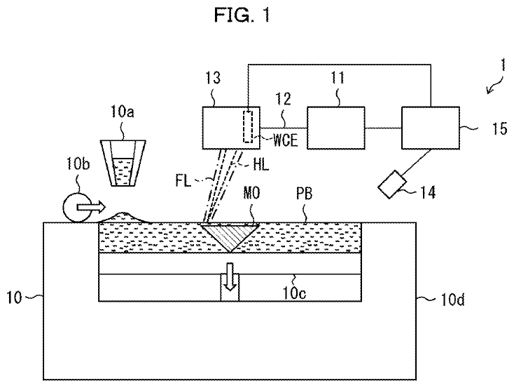

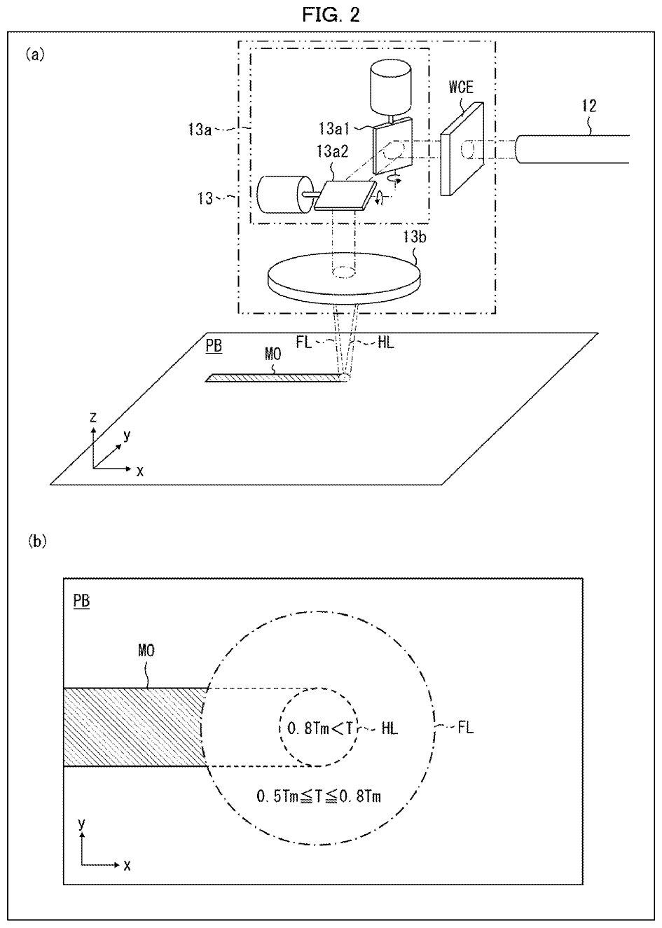

The following description will discuss a metal shaping system 1 in accordance with an embodiment of the present invention with reference to FIGS. 1 and 2. FIG. 1 is a diagram illustrating a configuration of the metal shaping system 1. FIG. 2 is a diagram illustrating a configuration of an irradiation device 13 included in the metal shaping system 1.

The metal shaping system 1 is a system for additive manufacturing of a three-dimensional metal shaped object MO. As illustrated in FIG. 1, the metal shaping system 1 includes a shaping table 10, a laser device 11, an optical fiber 12, an irradiation device 13, a measuring section 14, and a control section 15. In this specification, a main part of the metal shaping system 1 is referred to as “metal shaping device”. The metal shaping device includes at least the laser device 11 and the irradiation device 13, and may also include the optical fiber 12, the measuring section 14 and the control section 15.

In this section, the shaping table 10, the laser device 11, the optical fiber 12, and the irradiation device 13 will be described, and then effects brought about by those constituent members will be described. The measuring section 14 and the control section 15 will be described in the next section.

The shaping table 10 is a constituent member for holding a powder bed PB. The shaping table 10 can be constituted by, for example, a recoater 10a, a roller 10b, a stage 10c and a table main body 10d which is equipped with the recoater 10a, the roller 10b, and the stage 10c (see FIG. 1). The recoater 10a is a member for supplying metal powder. The roller 10b is a member for spreading the metal powder supplied by the recoater 10a evenly over the stage 10c. The stage 10c is a member on which the metal powder evenly spread by the roller 10b is to be placed, and the stage 10c is configured to be elevated and lowered. The powder bed PB contains the metal powder which has been evenly spread over the stage 10c. The metal shaped object MO is formed layer by layer such that each layer has a predetermined thickness, by repeating the following steps (1) through (3): i.e., (1) a step of forming a powder bed PB on the stage 10c as described above; (2) a step of forming one layer of the metal shaped object MO by irradiating the powder bed PB with harmonic wave light HL as described later; and (3) a step of lowering the stage 10c by one layer.

The shaping table 10 only needs to serve a function of holding the powder bed PB, and the configuration of the shaping table 10 is not limited to the configuration described above. For example, a configuration can be employed in which a powder bath containing the metal powder is provided instead of the recoater 10a and the metal powder is supplied by elevating a bottom plate of the powder bath.

The laser device 11 is a constituent member for outputting laser light. In the present embodiment, a fiber laser is used as the laser device 11. The fiber laser used as the laser device 11 can be a resonator type fiber laser or a master oscillator-power amplifier (MOPA) type fiber laser. In other words, the laser device 11 can be a continuous-wave type fiber laser or a pulsed oscillation type fiber laser. Alternatively, the laser device 11 can be a laser device other than the fiber laser. Any laser device such as a solid laser, a liquid laser, or a gas laser can be used as the laser device 11.

The optical fiber 12 is a constituent member which guides laser light outputted from the laser device 11. In the present embodiment, a double cladding fiber is used as the optical fiber 12. Note that the optical fiber 12 is not limited to the double cladding fiber. Any optical fiber, such as a single cladding fiber or a triple cladding fiber, can be used as the optical fiber 12.

The irradiation device 13 is a constituent member for (a) converting the laser light guided through the optical fiber 12 to laser light containing harmonic wave light HL which has a shorter wavelength than the laser light guided through the optical fiber 12 and (b) irradiating the powder bed PB with the laser light containing the harmonic wave light HL. In the present embodiment, a galvano-type irradiation device including a wavelength converting element WCE is used as the irradiation device 13. That is, as illustrated in (a) of FIG. 2, the irradiation device 13 includes (i) the wavelength converting element WCE, (ii) a galvano scanner 13a (an example of an “irradiating section” in claims) including a first galvano mirror 13a1 and a second galvano mirror 13a2, (iii) a condensing lens 13b, and (iv) a housing (not illustrated) for accommodating those components (i) to (iii). The wavelength converting element WCE can be made of, for example, a crystal of KTP, beta-BBO, LBO, CLBO, DKDP, ADP, KDP, LiIO₃, KNbO₃, LiNbO₃, AgGaS₂, AgGaSe₂, or the like. The laser light outputted from the optical fiber 12 is converted to the laser light containing harmonic wave light HL which has a shorter wavelength than the laser light outputted from the optical fiber 12. The harmonic wave light HL outputted from the wavelength converting element WCE is (1) reflected by the first galvano mirror 13a1, (2) reflected by the second galvano mirror 13a2, (3) condensed by the condensing lens 13b, and then emitted to the powder bed PB.

The laser light outputted from the wavelength converting element WCE may also contain, in addition to the harmonic wave light HL, laser light which has remained unconverted to the harmonic wave light HL by the wavelength converting element WCE, that is, fundamental wave light FL which has a wavelength equal to that of the laser light outputted from the optical fiber 12. The fundamental wave light FL outputted from the wavelength converting element WCE, like the harmonic wave light HL outputted from the wavelength converting element WCE, is (1) reflected by the first galvano mirror 13a1, (2) reflected by the second galvano mirror 13a2, (3) condensed by the condensing lens 13b, and then emitted to the powder bed PB. Note that the laser light outputted from the wavelength converting element WCE can contain only the harmonic wave light HL (i.e., need not contain the fundamental wave light FL). In order that the laser light outputted from the wavelength converting element WCE may contain only the harmonic wave light HL, for example, the wavelength converting element WCE can be arranged to have a conversion efficiency set to a value close to 100%. In this case, for example, residual excitation light can be removed by a filter when light after wavelength conversion is re-coupled to a single mode fiber (not illustrated). The following will describe a case in which the laser light outputted from the wavelength converting element WCE mainly contains the fundamental wave light FL in addition to the harmonic wave light HL.

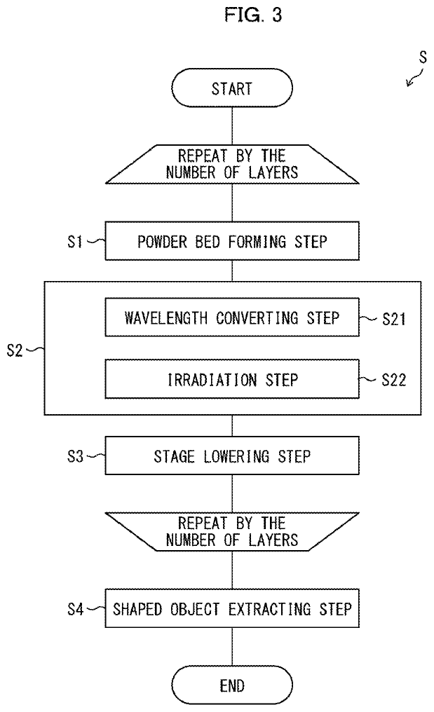

Here, the first galvano mirror 13a1 is a constituent member for moving beam spots of the harmonic wave light HL and the fundamental wave light FL formed on a surface of the powder bed PB in a first direction (e.g., an x-axis direction indicated in FIG. 3). The second galvano mirror 13a2 is a constituent member for moving the beam spots of the harmonic wave light HL and the fundamental wave light FL formed on the surface of the powder bed PB in a second direction (e.g., a y-axis direction indicated in FIG. 3) that intersects (e.g., is orthogonal to) the first direction. The condensing lens 13b is a constituent member for reducing diameters of the beam spots of the harmonic wave light HL and the fundamental wave light FL on the surface of the powder bed PB.

Note that the beam spot diameter of the harmonic wave light HL on the surface of the powder bed PB can either be identical with or different from a beam waist diameter of the harmonic wave light HL condensed by the condensing lens 13b. Alternatively, the beam spot diameter of the harmonic wave light HL on the surface of the powder bed PB can be adjusted so that an energy density of the harmonic wave light HL with which the powder bed PB is irradiated becomes an intended energy density. In this case, the beam spot diameter of the harmonic wave light HL on the surface of the powder bed PB is larger than the beam waist diameter of the harmonic wave light HL condensed by the condensing lens 13b.

As illustrated in (b) of FIG. 2, the beam spot of the fundamental wave light FL on the surface of the powder bed PB includes the beam spot of the harmonic wave light HL on the surface of the powder bed PB. That is, the size of the beam spot of the fundamental wave light FL on the surface of the powder bed PB is larger than the size of the beam spot of the harmonic wave light HL on the surface of the powder bed PB. Such an inclusion relation of the beam spots can be achieved by: (1) using, as the wavelength converting element WCE, a wavelength converting element which outputs, together with the harmonic wave light HL, the fundamental wave light FL whose beam spot is larger in size than the beam spot of the harmonic wave light HL, or (2) using, as the condensing lens 13b, a condensing lens which has a chromatic aberration. The inclusion relation of the beam spots can be achieved by using, as the condensing lens 13b, the condensing lens having a chromatic aberration as described above, because a focal distance of the condensing lens 13b with respect to the fundamental wave light FL is different from that with respect to the harmonic wave light HL since the wavelength of the fundamental wave light FL is longer than that of the harmonic wave light HL.

Note that although the irradiation device 13 in accordance with the present invention is configured such that the wavelength converting element WCE is provided on an upstream side of the galvano scanner 13a (on a side closer to a light source of the laser light) in an optical path of the laser light, the irradiation device 13 is not limited to such a configuration. In other words, the irradiation device 13 in accordance with the present embodiment can alternatively be configured such that the wavelength converting element WCE is provided on a downstream side of the galvano scanner 13a (on a side farther from the light source of the laser light) in the optical path of the laser light.

As described above, the irradiation device 13 in accordance with the present embodiment includes (1) the galvano scanner 13a which irradiates at least part of the powder bed PB with the laser light outputted from the laser device 11 (an example of the “irradiating section” in claims), and (2) the wavelength converting element WCE which is provided in the optical path of the laser light outputted from the laser device 11 and which converts the wavelength laser light inputted into the wavelength converting element WCE to the laser light containing the harmonic wave light HL which has a shorter wavelength than the laser light inputted into the wavelength converting element WCE.

Accordingly, the irradiation device 13 in accordance with the present embodiment can allow the powder bed PB to be irradiated with the laser light having a shorter wavelength as compared to a case where the laser light outputted from the laser device 11 is directly used for irradiation on the powder bed PB. Therefore, as compared to the case where the laser light outputted from the laser device 11 is directly used for irradiation on the powder bed PB, it is possible to increase the absorption efficiency of the laser light into the metal powder constituting the powder bed PB. Consequently, as compared to the case where the laser light outputted from the laser device 11 is directly used for irradiation on the powder bed PB, the irradiation device 13 makes it easy to increase the temperature of the metal powder constituting the powder bed PB to a temperature at which the powder bed PB is sintered or melted. This is an effect of the irradiation device 13 in accordance with an embodiment of the present invention. Further, the irradiation device 13 in accordance with the present embodiment can bring about the effect with a relatively simple configuration including the galvano scanner 13a and the wavelength converting element WCE. Meanwhile, the wavelength of the laser light can be converted by only causing the laser light to pass through the wavelength converting element WCE, without the need of replacing the laser device 11 by another laser device having an oscillation wavelength different from that of the laser device 11. This makes it possible to easily adjust the wavelength of the laser light. Note that the metal shaping device including the irradiation device 13 in accordance with the present embodiment and a metal shaping system 1 including the metal shaping device also bring about similar effects.

Further, as described above, in the irradiation device 13 in accordance with the present embodiment, the laser light outputted from the wavelength converting element WCE may contain the fundamental wave light FL having a wavelength equal to that of the laser light inputted into the wavelength converting element WCE. In this case, with regard to a specific region of the powder bed PB, the irradiation device 13 in accordance with the present embodiment can carry out auxiliary heating by the fundamental wave light FL before or after main heating by the harmonic wave light HL. This makes it possible to reduce the difference in temperature between a region subjected to main heating and its surrounding regions. In other words, it is possible to gradually increase the temperature of the metal powder at the start of main heating or to gradually decrease the temperature of at least one or some of layers of the metal shaped object MO which are solidified or sintered after the end of the main heating. This makes it possible to suppress residual stress, which may occur in the metal shaped object MO, to a low level (e.g., to a level similar to that in the case of the metal shaping device using an electron beam). What is more, the main heating by the harmonic wave light HL and the auxiliary heating by the fundamental wave light FL are carried out concurrently. In particular, in the present embodiment, irradiation with the harmonic wave light HL and irradiation with the fundamental wave light FL are carried out by one galvano scanner 13a. On this account, the main heating by the harmonic wave light HL and the auxiliary heating by the fundamental wave light FL are carried out at narrowly spaced intervals (time intervals and/or spatial intervals). Therefore, it is unnecessary to take an additional time for the auxiliary heating. Further, it is also unnecessary to provide additional equipment for carrying out the auxiliary heating. As a resultant effect, it is possible to suppress the residual stress which may occur in a complete metal shaped object while taking a shorter time for additive manufacturing of the metal shaped object. The “main heating” here refers to heating of the powder bed PB to a degree at which the metal powder is sintered or melted. On the other hand, the auxiliary heating refers to heating of the powder bed PB to a degree at which the metal powder is temporarily sintered. The metal shaping device including the irradiation device 13 in accordance with the present embodiment and the metal shaping system 1 including the metal shaping device also bring about similar effects.

Note that it is preferable that the irradiation device 13 carry out the main heating of the powder bed PB with use of the harmonic wave light HL so that the temperature T of the powder bed PB increases to a temperature which is higher than 0.8 times as high as the melting point Tm of the metal powder (metal powder contained in the powder bed PB; hereafter, the same applies). Note also that in the beam spot of the harmonic wave light HL, irradiation with the fundamental wave light FL can concurrently occur in addition to irradiation with the harmonic wave light HL. Thus, the main heating described in this paragraph includes: (1) an aspect in which the temperature T of the powder bed PB is increased, with only the harmonic wave light HL, to be higher than 0.8 times as high as the melting point Tm of the metal powder in the beam spot of the harmonic wave light HL; and (2) an aspect in which the temperature T of the powder bed PB is increased, with the harmonic wave light HL and the fundamental wave light FL, to be higher than 0.8 times as high as the melting point Tm of the metal powder in the beam spot of the harmonic wave light HL.

In particular, in a case where each layer of the metal shaped object MO is formed by melting and solidifying the metal powder, it is preferable that the irradiation device 13 emit the harmonic wave light HL so that the main heating of the powder bed PB will increase the temperature T of the powder bed PB to a temperature equal to or higher than the melting point Tm of the metal powder. In this case, when the powder bed PB is scanned with the harmonic wave light HL, the powder bed PB is melted and solidified on a track of the beam spot of the harmonic wave light HL. This forms each layer of the metal shaped object MO. Note that, in the beam spot of the harmonic wave light HL, irradiation with the fundamental wave light FL can concurrently occur in addition to irradiation with the harmonic wave light HL. Thus, the main heating described in this paragraph includes: (1) an aspect in which the temperature T of the powder bed PB is increased, with only the harmonic wave light HL, to be equal to or higher than the melting point Tm of the metal powder in the beam spot of the harmonic wave light HL; and (2) an aspect in which the temperature T of the powder bed PB is increased, with the harmonic wave light HL and the fundamental wave light FL, to be equal to or higher than the melting point Tm of the metal powder in the beam spot of the harmonic wave light HL.

On the other hand, in a case where each layer of the metal shaped object MO is formed by sintering the metal powder, it is preferable that the irradiation device 13 emit the harmonic wave light HL so that the main heating of the powder bed PB increases the temperature T of the powder bed PB to a temperature that is (i) higher than 0.8 times as high as the melting point Tm of the metal powder and (ii) lower than the melting point Tm of the metal powder. In this case, when the powder bed PB is scanned with the harmonic wave light HL, the powder bed PB is sintered on a track of the beam spot of the harmonic wave light HL. This forms each layer of the metal shaped object MO. Note that, in the beam spot of the harmonic wave light HL, irradiation with the fundamental wave light FL can concurrently occur in addition to irradiation with the harmonic wave light HL. Thus, the main heating described in this paragraph includes: (1) an aspect in which the temperature T of the powder bed PB is increased, with only the harmonic wave light HL, to be (i) higher than 0.8 times as high as the melting point Tm of the metal powder and (ii) lower than the melting point Tm of the metal powder in the beam spot of the harmonic wave light HL; and (2) an aspect in which the temperature T of the powder bed PB is increased, with the harmonic wave light HL and the fundamental wave light FL, to be (i) higher than 0.8 times as high as the melting point Tm of the metal powder and (ii) lower than the melting point Tm of the metal powder in the beam spot of the harmonic wave light HL.

Further, it is preferable that the irradiation device 13 emit the fundamental wave light FL so that the auxiliary heating of the powder bed PB increases the temperature T of the powder bed PB to a temperature that is 0.5 times to 0.8 times as high as the melting point Tm of the metal powder. In this case, when the powder bed PB is scanned with the fundamental wave light FL, the powder bed PB is heated on a track of the beam spot of the fundamental wave light FL. In particular, in a case where a region on the powder bed which has not yet been irradiated with the harmonic wave light HL is scanned with the fundamental wave light, the powder bed PB is temporarily sintered on the track of the beam spot of the fundamental wave light FL.

As described above, it is preferable that in the irradiation device 13 in accordance with the present embodiment, (1) the main heating of the powder bed be carried out with the harmonic wave light HL so that the temperature T of the powder bed PB increases to a temperature higher than 0.8 times as high as the melting point Tm of the metal powder, and (2) the auxiliary heating of the powder bed PB be carried out with the fundamental wave light FL so that the temperature T of the powder bed PB increases to a temperature that is 0.5 times to 0.8 times as high as the melting point Tm of the metal powder. The auxiliary heating before or after the main heating means that with regard to a specific region of the bed PB, the auxiliary heating is carried out before or after the main heating is carried out. As a resultant effect, the irradiation device 13 in accordance with the present embodiment makes it possible to further reduce the residual stress in the metal shaped object MO. The metal shaping device including the irradiation device 13 in accordance with the present embodiment and the metal shaping system 1 including the metal shaping device also provide a similar effect.

Note that the following advantages can be obtained by employing a configuration in which the auxiliary heating is carried out before the main heating. The first advantage is that the lamination density in the metal shaped object MO is unlikely to lower. That is, in a case where the auxiliary heating is not carried out before the main heating, the powder bed PB is rapidly heated during the main heating. From this, a metallic liquid produced by melting of the metal powder tends to have a high momentum, and consequently flatness of a surface of a metallic solid produced by solidification of the metallic liquid tends to be deteriorated. As a result, the lamination density of the metal shaped object MO easily lowers. In contrast, in a case where the auxiliary heating is carried out before the main heating, it is possible to have a slower increase in temperature of the powder bed PB during the main heating. This makes it difficult for the metallic liquid produced by melting of the metal powder to have a high momentum, and consequently the flatness of the surface of the metallic solid produced by solidification of the metallic liquid is unlikely to be deteriorated. As a result, the lamination density of the metal shaped object MO is unlikely to lower.

The second advantage is that it is possible to reduce power of the harmonic wave light HL emitted during the main heating. The power of the harmonic wave light HL emitted during the main heating can be kept low because the temperature T of the powder bed PB in carrying out the main heating has already been increased to some extent by the auxiliary heating.

The third advantage is that a variation in temperature T of the powder bed PB depending on locations during the main heating can be kept small. For example, the following description assumes a case where the temperature T of the powder bed PB is increased from 20° C. to 1000° C. by carrying out main heating without auxiliary heating. In this case, an increase in temperature during the main heating is approximately 1000° C. Thus, if the variation is ±10%, the temperature T of the powder bed PB during the main heating will vary in a range from approximately 900° C. to approximately 1100° C. If the variation of the temperature T of the powder bed PB during the main heating is large as described above, a problem tends to occur in which excessive heating is carried out at a certain location, and insufficient heating is carried out at another location. In contrast, the following description assumes a case where the temperature T of the powder bed PB is increased to 600° C. by carrying out auxiliary heating and then the temperature T of the powder bed PB is increased from 600° C. to 1000° C. by carrying out main heating. In this case, the increase in temperature during the main heating is approximately 400° C. Thus, if the variation is ±10%, the temperature T of the powder bed PB during the main heating will vary in a range from approximately 960° C. to approximately 1040° C. In a case where the variation of the temperature T of the powder bed PB during the main heating is small in this way, the problem is unlikely to occur in which excessive heating is carried out at a certain location, and insufficient heating is carried out at another location.

Meanwhile, in a case where the auxiliary heating is carried out after the main heating, an advantage of further reducing the residual stress, which may occur in the metal shaped object MO, can be obtained. This is because it is possible to (i) reduce, by the auxiliary heating, a difference in temperature between a region subjected to main heating and its surrounding regions and, in addition, (ii) have a slower decrease in temperature of at least one or some layers of the solidified or sintered metal shaped object MO after the end of the main heating.

Further, as described above, the irradiation device 13 in accordance with the present embodiment further includes the condensing lens 13b for forming, on the surface of the powder bed PB, (a) a beam spot of the harmonic wave light HL and (b) a beam spot of the fundamental wave light FL having a beam spot size larger than the harmonic wave light HL. Accordingly, the irradiation device 13 can increase power densities of the harmonic wave light HL and the fundamental wave light FL with which the powder bed PB is irradiated. From this, even in a case where powers of the harmonic wave light HL and the fundamental wave light FL are relatively low, the temperature T of the powder bed PB in the beam spots of the harmonic wave light HL and the fundamental wave light FL can be increased sufficiently. This makes it possible to bring about an effect of reducing electric power which is to be consumed for increasing the temperature T of the powder bed PB in the beam spots of the harmonic wave light HL and the fundamental wave light FL. The metal shaping device including the irradiation device 13 and the metal shaping system 1 including the metal shaping device also bring about similar effects.

Further, as described above, in the irradiation device in accordance with the present embodiment, the wavelength converting element WCE is provided on the upstream side of the galvano scanner 13a in the optical path of the laser light. In other words, the wavelength converting element WCE is provided in the optical path of the laser light between the laser device 11 and the galvano scanner 13a, or in the optical path of the laser light inside the laser device 11 (e.g., in the vicinity of a laser emission end). Therefore, in the irradiation device 13 in accordance with the present embodiment, in a case where the beam spot of the laser light is moved with use of the galvano scanner 13a, it is not necessary to additionally move the wavelength converting element WCE. As a resultant effect, the irradiation device 13 can have a simpler configuration in which, for example, a mechanism for moving the wavelength converting element WCE is omitted. The metal shaping device including the irradiation device 13 in accordance with the present embodiment and the metal shaping system 1 including the metal shaping device also bring about similar effects. In particular the, the metal shaping device including the irradiation device 13 in accordance with the present embodiment can reduce damage caused by external force to the wavelength converting element WCE since the wavelength converting element WCE is contained in the metal shaping device. Meanwhile, the metal shaping device including the irradiation device 13 in accordance with the present embodiment can improve stability in wavelength conversion since the wavelength conversion is less influenced by external force.

Note that although the present embodiment has dealt with an example configuration in which the wavelength converting element WCE is contained in the irradiation device 13, an embodiment of the present invention is not limited to such a configuration. In other words, the present invention encompasses a configuration in which the wavelength converting element WCE is not contained in the irradiation device 13. For example, the wavelength converting element WCE can be inserted in an optical fiber 12. In order to provide such a configuration, for example, a spatial optical system can be used in which (i) the optical fiber 12 is made of two optical fibers including a first optical fiber and a second optical fiber and (ii) laser light emitted from the first optical fiber is collimated and caused to enter the wavelength converting element WCE, and then, the laser light outputted from the wavelength converting element WCE is condensed and caused to enter the second optical fiber. Alternatively, the wavelength converting element WCE can be provided between the irradiation device 13 and the powder bed PB. In other words, provided that the wavelength converting element WCE is provided in the optical path of the laser light, the wavelength converting element WCE can be provided at any position inside or outside the irradiation device 13.

(Measuring Section and Control Section)

As described above, the metal shaping device can include the measuring section 14 and the control section 15. In this section, the measuring section 14 and the control section 15 will be described. In FIG. 1, the line connecting the measuring section 14 with the control section 15 represents a signal line for transmitting a signal indicative of a measured result obtained by the measuring section 14 to the control section 15, and the measuring section 14 and the control section 15 are electrically or optically connected to each other. Further, in FIG. 1, the line connecting the control section 15 with the laser device 11 represents a signal line for transmitting a control signal generated by the control section 15 to the laser device 11, and the line connecting the control section 15 with the wavelength converting element WCE represents a signal line for transmitting a control signal generated by the control section 15 to the wavelength converting element WCE. The control section 15 and the laser device 11 are electrically or optically connected to each other, and the control section 15 and the wavelength converting element WCE are electrically or optically connected to each other.

The measuring section 14 is a constituent member for measuring a temperature T (e.g., a surface temperature) of the powder bed PB. As the measuring section 14, for example, a thermographic camera can be used.

The control section 15 is a constituent member for controlling the conversion efficiency of the wavelength converting element WCE so that (1) irradiation with the harmonic wave light HL causes the temperature T of the powder bed PB to be higher than 0.8 times as high as the melting point Tm of the metal powder. Concurrently, the control section 15 is a constituent member for controlling the conversion efficiency of the wavelength converting element WCE so that (2) irradiation with the fundamental wave light FL causes the temperature T of the powder bed PB to be 0.5 times to 0.8 times as high as the melting point Tm of the metal powder. As described above, Tm refers to the melting point of the metal powder contained in the powder bed PB.

In the present embodiment, the control section 15 controls the conversion efficiency of the wavelength converting element WCE in accordance with a temperature measured by the measuring section 14. As the control section 15, for example, a microcomputer can be used. The conversion efficiency of the wavelength converting element WCE can be controlled by, for example, (1) changing the conversion efficiency of the wavelength converting element WCE by changing the temperature of a crystal constituting the wavelength converting element WCE. The conversion efficiency of the wavelength converting element WCE can be also controlled in another way, by changing the conversion efficiency of the wavelength converting element WCE by changing an orientation of the crystal constituting the wavelength converting element WCE (changing an incident angle of the laser light with respect to the crystal). Note that the control section 15 can control power of the laser light outputted from the laser device 11.

According to the metal shaping device including the measuring section 14 and the control section 15, and the metal shaping system 1 including such a metal shaping device, it is possible to bring about an effect of appropriately carrying out the main heating with the harmonic wave light HL and the auxiliary heating with the fundamental wave light FL even in a case where various conditions change.

(Method for Manufacturing Metal Shaped Object)

The following description will discuss a manufacturing method S for manufacturing a metal shaped object MO using the metal shaping system 1 with reference to FIG. 3. FIG. 3 is a flowchart showing a flow of the manufacturing method S.

As illustrated in FIG. 3, the manufacturing method S includes a powder bed forming step S1, a laser light irradiation step S2 (an example of “irradiation method” in claims), a stage lowering step S3, and a shaped object extracting step S4. The metal shaped object MO is formed layer by layer as described earlier. The powder bed forming step S1, the laser light irradiation step S2, and the stage lowering step S3 are repeatedly carried out the number of times which corresponds to the number of layers.

The powder bed forming step S1 is a process of forming a powder bed PB on the stage 10c of the shaping table 10. The powder bed forming step S1 can be realized by, for example, (1) a step of supplying metal powder with use of the recoater 10a, and (2) a step of evenly spreading the metal powder over the stage 10c with use of the roller 10b.

The laser light irradiation step S2 is a process of forming one layer of the metal shaped object MO by irradiating the powder bed PB with laser light. The laser light irradiation step S2 includes (1) a wavelength conversion sub-step S21 of converting, with use of the wavelength converting element WCE, laser light inputted into the wavelength converting element WCE to laser light containing harmonic wave light HL having a shorter wavelength than the laser light inputted in to the wavelength conversion element WCE, and (2) an irradiation sub-step S22 of irradiating the powder bed PB with the laser light containing the harmonic wave light HL. This subjects the powder bead PB to main heating with use of the harmonic wave light HL. In a case where the laser light outputted from the wavelength converting element WCE contains fundamental wave light FL, auxiliary heating with the fundamental light FL is carried out before or after the main heating of the powder bed PB with the harmonic wave light HL. The expression “auxiliary heating with the fundamental light FL is carried out before or after the main heating” here means that with regard to a specific region of the powder bed PB, the auxiliary heating is carried out before or after the main heating.

The stage lowering step S3 is a process of lowering the stage 10c of the shaping table 10 by one layer. This allows a new powder bed PB to be formed on the stage 10c. A metal shaped object MO is obtained by repeating the powder bed forming step S1, the laser light irradiation step S2, and the stage lowering step S3 the number of times which corresponds to the number of layers.

The shaped object extracting step S4 is a process of extracting a resultant metal shaped object MO from the powder bed PB. Thus, the metal shaped object MO is completed.

The laser light irradiation step S2, and the manufacturing method S of a metal shaped object including the laser light irradiation step S2 bring about an effect of making it easier to increase the temperature T of the metal powder constituting the powder bed PB to a temperature at which the powder bed PB is sintered or melted, as compared to a case where the powder bed PB is irradiated with the laser light which has not been converted. Further, as another effect, in a case where the laser light outputted from the wavelength converting element WCE contains the fundamental wave light FL, it is possible to suppress, to a low level, residual stress which may occur in the metal shaped object MO while avoiding taking an additional time for carrying out auxiliary heating.

Aspects of the present invention can also be expressed as follows:

An irradiation device (13) in accordance with an aspect of the present invention is an irradiation device (13) for use in metal shaping, the irradiation device (13) including: an irradiating section (13a) which irradiates at least part of a powder bed (PB) with laser light; and a wavelength converting element (WCE) provided in an optical path of the laser light, the wavelength converting element (WCE) converting laser light inputted into the wavelength converting element (WCE) to laser light containing harmonic wave light (HL) which has a shorter wavelength than the laser light inputted into the wavelength converting element (WCE).

An irradiation device (13) in accordance with an aspect of the present invention is an irradiation device (13) for use in metal shaping, the irradiation device (13) including: a laser device (11) which outputs laser light with which at least part of a powder bed (PB) is irradiated; and a wavelength converting element (WCE) provided in an optical path of the laser light, the wavelength converting element (WCE) converting laser light inputted into the wavelength converting element (WCE) to laser light containing harmonic wave light (HL) which has a shorter wavelength than the laser light inputted into the wavelength converting element (WCE).

The irradiation device (13) in accordance with an aspect of the present invention is preferably configured such that the wavelength converting element (WCE) is provided on an upstream side of the irradiating section (13a) in the optical path of the laser light.

The irradiation device (13) in accordance with an aspect of the present invention is preferably configured such that the laser light outputted from the wavelength converting element (WCE) contains, in addition to the harmonic wave light (HL), fundamental wave light (FL) which has a same wavelength as the laser light inputted into the wavelength converting element (WCE).

The irradiation device (13) in accordance with an aspect of the present invention is preferably configured such that: the harmonic wave light (HL) heats the powder bed (PB) so that a temperature (T) of the powder bed (PB) is higher than 0.8 times as high as a melting point (Tm) of metal powder contained in the powder bed (PB); and the fundamental wave light (FL) heats the powder bed (PB) so that the temperature (T) of the powder bed (PB) is 0.5 times to 0.8 times as high as the melting point (Tm) of the metal powder, before or after the harmonic wave light (HL) heats the powder bed (PB).

The irradiation device (13) in accordance with an aspect of the present invention is preferably configured such that a condensing lens (13b) which forms, on a surface of the powder bed (PB), a beam spot of the harmonic wave light (HL) and a beam spot of the fundamental wave light (FL), the beam spot of the fundamental wave light (FL) being larger in size than the beam spot of the harmonic wave light (HL).

A metal shaping device in accordance with an aspect of the present invention is preferably configured to include: an irradiation device (13) in accordance with an aspect of the present invention; and a control section (15) which controls conversion efficiency of the wavelength converting element (WCE) so that (i) the temperature (T) of the powder bed (PB) heated by the harmonic wave light (HL) is higher than 0.8 times as high as the melting point (Tm) of the metal powder contained in the powder bed (PB) and (ii) the temperature (T) of the powder bed (PB) heated by the fundamental wave light (FL) is 0.5 times to 0.8 times as high as the melting point (Tm) of the metal powder.

The metal shaping device in accordance with an aspect of the present invention is preferably configured to further include a measuring section (14) which measures the temperature (T) of the powder bed (PB), the control section (15) carrying out control on the conversion efficiency of the wavelength converting element (WCE), based on the temperature measured by the measuring section (14).

A metal shaping system (1) in accordance with an aspect of the present invention is preferably configured to include: a metal shaping device in accordance with an aspect of the present invention; and a shaping table (10) for holding the powder bed (PB).

An irradiation method in accordance with an aspect of the present invention is a method including the steps of: converting, with use of a wavelength converting element (WCE), laser light inputted into the wavelength converting element (WCE) to laser light containing harmonic wave light (HL) which has a shorter wavelength than the laser light inputted into the wavelength converting element (WCE); and irradiating the powder bed (PB) with the laser light containing the harmonic wave light (HL).

A method for manufacturing a metal shaped object in accordance with an aspect of the present invention is a method including the steps of: converting, with use of a wavelength converting element (WCE), laser light inputted into the wavelength converting element (WCE) to laser light containing harmonic wave light (HL) which has a shorter wavelength than the laser light inputted into the wavelength converting element (WCE); and irradiating the powder bed (PB) with the laser light containing the harmonic wave light (HL).

(Additional Remarks)

The present invention is not limited to the embodiments, but can be altered by a skilled person in the art within the scope of the claims. The present invention also encompasses, in its technical scope, any embodiment derived by combining technical means disclosed in differing embodiments.

For example, although the irradiation device 13 in the present embodiment includes at least the galvano scanner 13a and the wavelength converting element WCE, an irradiation device in accordance with an embodiment of the present invention is not limited to such a configuration. In other words, the present invention encompasses an irradiation device including at least the laser device 11 and the wavelength converting element WCE. Such an irradiation device including the laser device 11 and the wavelength converting element WCE also brings about an effect similar to that brought about by the irradiation device 13 including the galvano scanner 13a and the wavelength converting element WCE. In other words, as compared to a case where the laser light outputted from the laser device 11 is directly used for irradiation on the powder bed PB, the irradiation device including the laser device 11 and the wavelength converting element WCE brings about an effect of making it easier to increase the temperature T of the metal powder constituting the powder bed PB to a temperature at which the powder bed PB is sintered or melted. The irradiation device 13 in accordance with the present embodiment can also bring about the above-describe effect by a relatively simple configuration including the laser device 11 and the wavelength converting element WCE. Meanwhile, the wavelength of the laser light can be converted by only causing the laser light to pass through the wavelength converting element WCE, without the need of replacing the laser device 11 by another laser device having an oscillation wavelength different from that of the laser device 11. This makes it possible to easily adjust the wavelength of the laser light. The irradiation device including at least the laser device 11 and the wavelength converting element WCE can bring about effects similar to those of the irradiation device 13 described above except for the effect which is brought about by the galvano scanner 13a.

### REFERENCE SIGNS LIST

1 metal shaping system
10 shaping table
10a recoater
10b roller
10c stage
10d table main body
11 laser device
12 optical fiber
13 irradiation device
13a galvano scanner (irradiating section)
13a1 first galvano mirror
13a2 second galvano mirror
13b condensing lens
14 measuring section
15 control section
WCE wavelength converting element
HL harmonic wave light
FL fundamental wave light
PB powder bed
MO metal shaped object
T temperature of powder bed
Tm melting point of metal powder

1. An irradiation device for use in metal shaping, the irradiation device comprising:
an irradiating section which irradiates at least part of a powder bed with laser light; and
a wavelength converting element provided in an optical path of the laser light, the wavelength converting element converting laser light inputted into the wavelength converting element to laser light containing harmonic wave light which has a shorter wavelength than the laser light inputted into the wavelength converting element.

2. An irradiation device for use in metal shaping, the irradiation device comprising:
a laser device which outputs laser light with which at least part of a powder bed is irradiated; and
a wavelength converting element provided in an optical path of the laser light, the wavelength converting element converting laser light inputted into the wavelength converting element to laser light containing harmonic wave light which has a shorter wavelength than the laser light inputted into the wavelength converting element.

3. The irradiation device as set forth in claim 1, wherein:
the wavelength converting element is provided on an upstream side of the irradiating section in the optical path of the laser light.

4. The irradiation device as set forth in claim 1, wherein:
the laser light outputted from the wavelength converting element contains, in addition to the harmonic wave light, fundamental wave light which has a same wavelength as the laser light inputted into the wavelength converting element.

5. The irradiation device as set forth in claim 4, further comprising:
a condensing lens which forms, on a surface of the powder bed, a beam spot of the harmonic wave light and a beam spot of the fundamental wave light, the beam spot of the fundamental wave light being larger in size than the beam spot of the harmonic wave light.

6. The irradiation device as set forth in claim 4, wherein:
the harmonic wave light heats the powder bed so that a temperature of the powder bed is higher than 0.8 times as high as a melting point of metal powder contained in the powder bed; and
the fundamental wave light heats the powder bed so that the temperature of the powder bed is 0.5 times to 0.8 times as high as the melting point of the metal powder, before or after the harmonic wave light heats the powder bed.

7. A metal shaping device, comprising:
an irradiation device recited in claim 6; and
a control section which controls conversion efficiency of the wavelength converting element so that (i) the temperature of the powder bed heated by the harmonic wave light is higher than 0.8 times as high as the melting point of the metal powder contained in the powder bed and (ii) the temperature of the powder bed heated by the fundamental wave light is 0.5 times to 0.8 times as high as the melting point of the metal powder.

8. The metal shaping device as set forth in claim 7, further comprising:
a measuring section which measures the temperature of the powder bed,
the control section carrying out control on the conversion efficiency of the wavelength converting element, based on the temperature measured by the measuring section.

9. A metal shaping system, comprising:
a metal shaping device recited in claim 7; and
a shaping table for holding the powder bed.

10. An irradiation method, comprising the steps of:
converting, with use of a wavelength converting element, laser light inputted into the wavelength converting element to laser light containing harmonic wave light which has a shorter wavelength than the laser light inputted into the wavelength converting element; and
irradiating the powder bed with the laser light containing the harmonic wave light.

11. (canceled)
